(19) United States
(12) Patent Application Publication
(10) Pub. No.: US 2017/0104771 A1
(43) Pub. Date: Apr. 13, 2017

(54) NETWORK MONITORING DEVICE, NETWORK MONITORING METHOD, AND NETWORK MONITORING PROGRAM

(71) Applicant: FUJITSU LIMITED, Kawasaki-shi (JP)

(72) Inventors: Satomi Saito, Kawasaki (JP); Satoru Torii, Yokohama (JP); Hiroshi Tsuda, Fujisawa (JP)

(73) Assignee: FUJITSU LIMITED, Kawasaki-shi (JP)

(21) Appl. No.: 15/278,408

(22) Filed: Sep. 28, 2016

(30) Foreign Application Priority Data
Oct. 13, 2015 (JP) 2015-202233

(51) Int. Cl. H04L 29/06

(52) U.S. Cl. CPC H04L 63/1416; H04L 63/1425

(57) ABSTRACT

There is provided a network monitoring device including: a memory; and a processor coupled to the memory and the processor configured to: detect, based on history record information on attempts to log into a plurality of information processing devices from a plurality of terminals via a network, occurrences of attempts that were made to log into the plurality of information processing devices with common account information a predetermined number of times or less; and reject an attempt to log into an information processing device among the plurality of information processing devices from a terminal among the plurality of terminals and notify the terminal of a re-attempt to log into the information processing device after the occurrences of attempts are detected.

### CROSS-REFERENCE TO RELATED APPLICATION

This application is based upon and claims the benefit of priority of the prior Japanese Patent Application No. 2015-202233, filed on Oct. 13, 2015, the entire contents of which are incorporated herein by reference.

### FIELD

The embodiments discussed herein are related to a network monitoring device, a network monitoring method, and a network monitoring program.

### BACKGROUND

In order to invalidly identify account information (for example, a combination of a user name and a password) that enables to login to a server that provides a service through a network, an attack (or a brute-force attack) is made to attempt to log into the server from a terminal using all possible combinations of account information.

Taking measures such as the setting of an upper limit of the number of login attempts per unit of time and detecting the occurrence of the attack are effective against the brute-force attack.

An example of related art is Japanese Laid-open Patent Publication No. 2013-050816.

### SUMMARY

According to an aspect of the invention, a network monitoring device includes: a memory; and a processor coupled to the memory and the processor configured to: detect, based on history record information on attempts to log into a plurality of information processing devices from a plurality of terminals via a network, occurrences of attempts that were made to log into the plurality of information processing devices with common account information a predetermined number of times or less; and reject an attempt to log into an information processing device among the plurality of information processing devices from a terminal among the plurality of terminals and notify the terminal of a re-attempt to log into the information processing device after the occurrences of attempts are detected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the configuration of a system according to a first embodiment;

FIG. 2 is a diagram describing attacks expected in the first embodiment;

FIG. 3 is a diagram illustrating an example of a hardware configuration of a network monitoring device according to the first embodiment;

FIG. 4 is a diagram illustrating an example of a functional configuration of the network monitoring device according to the first embodiment;

FIG. 5 is a flowchart of an example of a procedure for a process of detecting an STBF according to the first embodiment;

FIG. 6 is a diagram illustrating an example of the configuration of an access log storage section;

FIG. 7 is a diagram illustrating a first example of the configuration of an analysis result storage section;

FIG. 8 is a diagram illustrating a second example of the configuration of the analysis result storage section;

FIG. 9 is a diagram illustrating an example of the configuration of a target server list storage section;

FIG. 10 is a flowchart of an example of a procedure for a process of blocking an STBF according to the first embodiment;

FIG. 11 is a diagram illustrating an example of the configuration of a monitoring record storage section;

FIG. 12 is a diagram illustrating an example of the timing of the blocking according to a second embodiment;

FIG. 13 is a diagram illustrating an example of a functional configuration of a network monitoring device according to the second embodiment;

FIG. 14 is a flowchart of an example of a procedure for a process of extracting a successful login record;

FIG. 15 is a diagram illustrating an example of the configuration of a login record storage section;

FIG. 16 is a flowchart of an example of a procedure for a process of estimating a future time and date when a login attempt by an STBF is made;

FIG. 17 is a diagram illustrating an example of an estimated time storage section; and

FIG. 18 is a flowchart of an example of a procedure for a process of blocking an STBF according to the second embodiment.

### DESCRIPTION OF EMBODIMENTS

A plurality of terminals has made an attack to attempt to log into each server once while changing account information, and the attacks have been monitored by the present inventor.

Since the number of attempts to log into each server in such an attack is 1 for the server, it is difficult to detect the attack based on an upper limit of the number of attempts to log into the server.

In addition, it is considered that an attempt to log into the server from a terminal that has never logged into the server is detected as the attack. In this case, however, if a valid user attempts to log into the server from a different terminal from a terminal usually used by the user, the attempt may be erroneously detected as the attack.

Hereinafter, embodiments of a technique for improving the accuracy of detecting an attack against each information processing device are described with reference to the accompanying drawings.

### First Embodiment

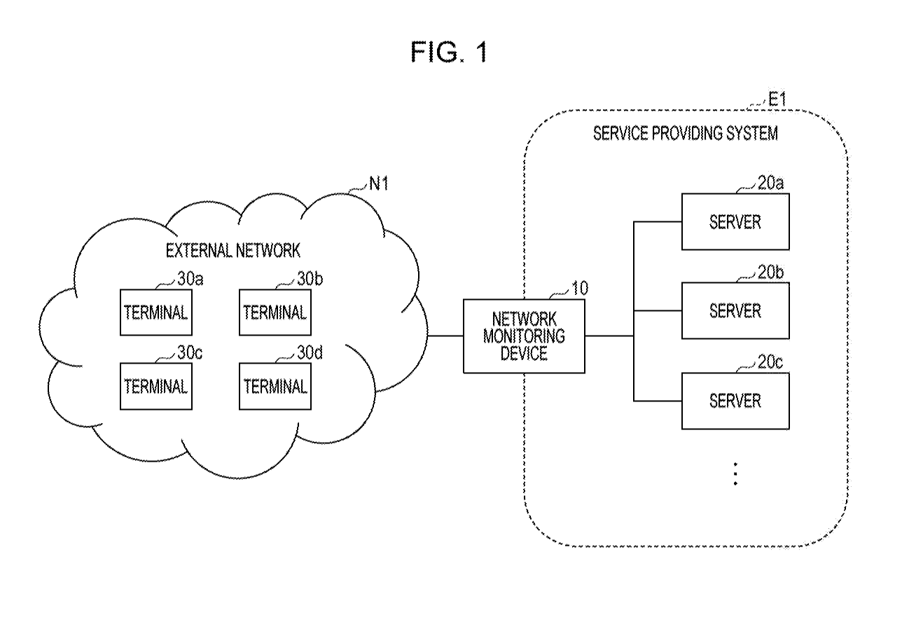

FIG. 1 is a diagram illustrating an example of the configuration of a system according to a first embodiment. In FIG. 1, a service providing system E1 is a system including server computers such as servers 20a, 20b, and 20c that provide services through a network. If the server computers are not distinguished from each other, the server computers are referred to as “servers 20”.

A network monitoring device 10 is a device in which one or more computers are installed to monitor access to the servers 20 through the network. For example, the network monitoring device 10 is installed at a boundary between the service providing system E1 and an external network N1. The network monitoring device 10 may not be a general-purpose computer and may be a dedicated device.

The external network N1 is a communication network that is the Internet or the like and arranged outside the service providing system E1. A plurality of information processing terminals such as terminals 30a, 30b, 30c, and 30d that access a service provided by any of the servers 20 is connected to the external network N1. If the information processing terminals are not distinguished from each other, the information processing terminals are referred to as “terminals 30”.

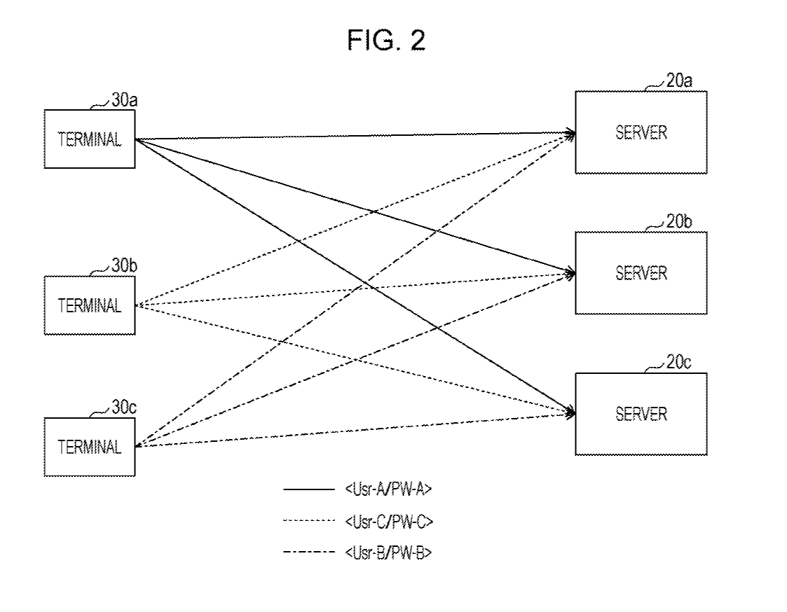

In order for a certain terminal 30 to access a service provided by a certain server 20, the certain terminal 30 successfully logs into the certain server 20 (or is authenticated) through the network. Specifically, the server 20 provides the service to the terminal 30 that has successfully logged into the server 20. In the external network N1, however, a terminal 30 that is used to make an attack in order to invalidly identify account information that enables the login may exist. For example, in the first embodiment, attacks indicated in FIG. 2 are expected.

FIG. 2 is a diagram describing the attacks expected in the first embodiment. In FIG. 2, the terminals 30a, 30b, and 30c are used by an invalid user. Arrows directed from the terminals 30 to the servers 20 indicate attempts (hereinafter also referred to as “login attempts”) to log into the servers 20 by the terminals 30. The login attempts indicate that the login was attempted regardless of whether the login was successful or failed. In addition, differences between the types (solid lines, broken lines, and alternate long and short dash lines) of the arrows indicate differences between account information used for the login attempts, as indicated on the lower side of FIG. 2.

For example, the invalid user uses the terminal 30a to attempt to log into each server 20 with account information <Usr-A/PW-A>. In FIG. 2, account information is in the form of <a user name and a password>. In addition, the invalid user uses the terminal 30b to attempt to log into each server 20 with account information <Usr-B/PW-B>. The invalid user uses the terminal 30c to attempt to log into each server 20 with account information <Usr-C/PW-C>. In FIG. 2, the three terminals 30 are illustrated as an example for convenience, but four or more terminals 30 may be used.

The number of attempts to log into a single server 20 by a single terminal 30 is 1. In the example illustrated in FIG. 2, each server 20 receives three login attempts. In this case, the user names included in the account information used for the three login attempts are different from each other, while the passwords included in the account information used for the three login attempts are different from each other. For the invalid user, the attacks indicated in FIG. 2 are brute-force attacks made using the plurality of terminals 30. It is, however, difficult for the servers 20 to detect the attacks as brute-force attacks based on a threshold for the number of login attempts from the same terminal 30. Specifically, for the servers 20, the attacks indicated in FIG. 2 are different from general brute-force attacks. In the first embodiment, such attacks as indicated in FIG. 2 are referred to as single-trial brute-force attacks (STBFs) for convenience. Attacks that are made by login attempts and whose number is equal to or lower than a threshold (threshold for the number of brute-force attacks) for the number of attempts to log into the same server 20 by the same terminal 30 may be considered as STBFs.

The network monitoring device 10 executes a process of detecting an STBF and a process of avoiding the identification of correct account information by an STBF. The network monitoring device 10 is described in detail below.

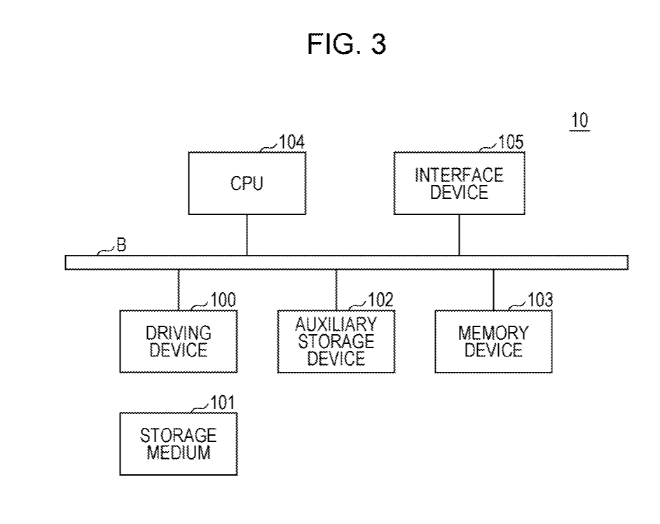

FIG. 3 is a diagram illustrating an example of a hardware configuration of the network monitoring device according to the first embodiment. The network monitoring device 10 illustrated in FIG. 3 includes a driving device 100, an auxiliary storage device 102, a memory device 103, a CPU 104, and an interface device 105 that are connected to each other by a bus B.

A program that achieves processes to be executed by the network monitoring device 10 is provided from a storage medium 101. When the storage medium 101 storing the program is set in the driving device 100, the program is installed in the auxiliary storage device 102 via the driving device 100 from the storage medium 101. The program, however, may not be installed from the storage medium 101 and may be downloaded into the auxiliary storage device 102 from another computer via the network. The auxiliary storage device 102 stores the installed program, files, data, and the like.

When an instruction to activate the program is provided, the memory device 103 reads the program from the auxiliary storage device 102 and stores the read program. The CPU 104 executes functions related to the network monitoring device 10 in accordance with the program stored in the memory storage 103. The interface device 105 is used as an interface to be connected to the network.

The storage medium 101 is a portable storage medium such as a CD-ROM, a DVD, or a USB memory, for example. The auxiliary storage device 102 is a hard disk drive (HDD), a flash memory, or the like, for example. The storage medium 101 and the auxiliary storage device 102 correspond to computer-readable storage media.

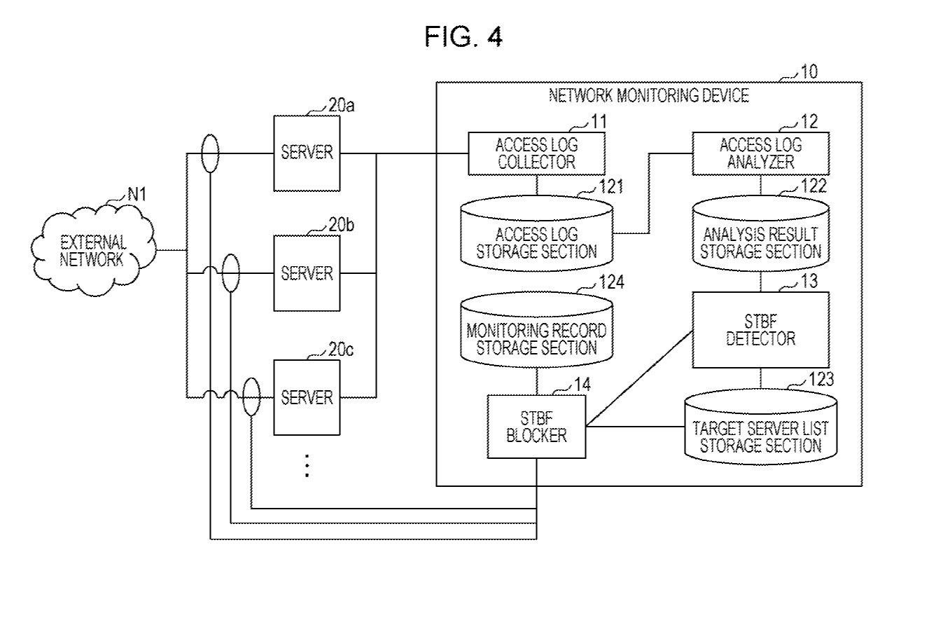

FIG. 4 is a diagram illustrating an example of a functional configuration of the network monitoring device according to the first embodiment. Referring to FIG. 4, the network monitoring device 10 includes an access log collector 11, an access log analyzer 12, an STBF detector 13, and an STBF blocker 14. These sections are achieved by a process of causing the CPU 104 to execute one or more programs installed in the network monitoring device 10. The network monitoring device 10 uses an access log storage section 121, an analysis result storage section 122, a target server list storage section 123, a monitoring record storage section 124, and the like. The storage sections may be achieved using the auxiliary storage device 102, a storage device able to be connected to the network monitoring device 10 via the network, or the like.

The access log collector 11 periodically acquires access logs from the servers 20 and causes the acquired access logs to be stored in the access log storage section 121, for example. The access logs are history record information on login attempts.

The access log analyzer 12 analyzes the access logs stored in the access log storage section 121 and generates, for each of combinations of the servers 20, the terminals 30, and account information, a group of times and dates when login attempts were made using the combination. The generated groups are stored in the analysis result storage section 122.

The STBF detector 13 references the analysis result storage section 122 and detects the occurrence of STBFs. Specifically, if the STBF detector 13 detects attempts to log into a plurality of servers 20 from a common terminal 20 with common account information, the STBF detector 13 determines that STBFs occurred. The STBF detector 13 causes information of a list of servers 20 determined to have received an attack as an STBF to be stored in the target server list storage section 123.

If the STBF detector 13 detects the occurrence of an STBF, the STBF blocker 14 executes a process (hereinafter referred to as “blocking process) of limiting (hereinafter referred to as “blocking”) a login attempt in order to avoid the identification of account information by the STBF. The blocking process according to the first embodiment includes the following two procedures, a first procedure and a second procedure.

In the first procedure, after the start of the blocking process, the STBF blocker 14 rejects the initial attempts to log into the servers 20 targeted for STBFs from the terminals 30, regardless of whether or not user names and passwords match correct account information.

In the second procedure, if an attempt to log into the same server 20 from the same terminal 30 is made after the rejection of the login attempts, the STBF blocker 14 determines that the login attempt was made by a valid user, and the STBF blocker 14 causes the server 20 targeted for the login attempt to determine, based on a user name and password specified in the login attempt, whether or not the login attempt is successful or fails.

Generally, if a valid user fails to log into a server in the first attempt, it is considered that the user may determine that the user input an incorrect user name or an incorrect password and the user may attempt to log into the server again at a high probability. In the first embodiment, such behavior characteristics of the valid user are used. Specifically, even if a valid user fails to log into a server 20 in the first procedure, the user may successfully log into the desired server 20 in the second procedure and use the desired server 20. On the other hand, since an attempt to log into a server 20 from the same terminal 30 using the same account information is made only once in an STBF, and all login attempts by STBFs may be blocked by the first procedure.

For each of login attempts, the name (hereinafter referred to as server name) of a server 20 targeted for the login attempt, an IP address of a terminal 30 that made the login attempt, and the time when the login attempt was made are stored in the monitoring record storage section 124.

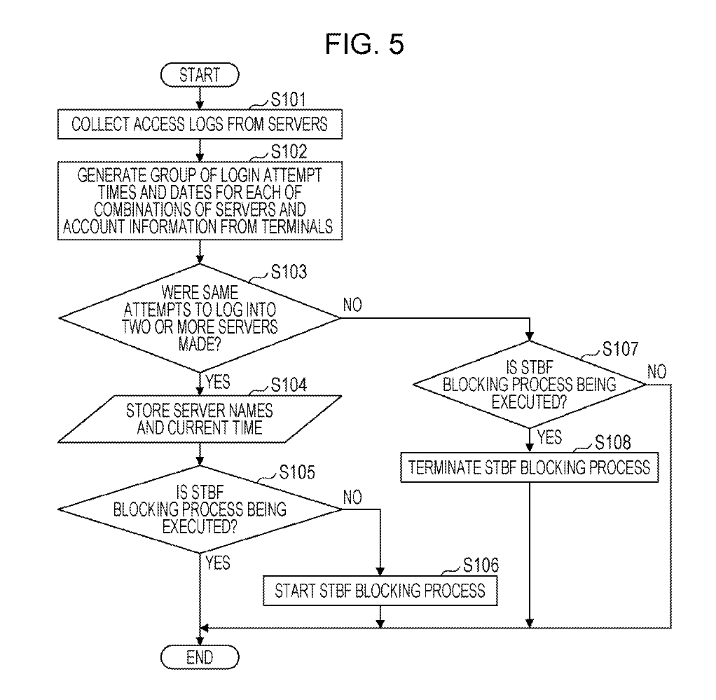

A procedure for a process to be executed by the network monitoring device 10 according to the first embodiment is described below. FIG. 5 is a flowchart of an example of the procedure for the process of detecting an STBF according to the first embodiment. The process procedure illustrated in FIG. 5 is executed at certain time intervals, for example. The process procedure illustrated in FIG. 5 may be executed at time intervals of 1 hour or 6 hours, for example. Alternatively, the process procedure illustrated in FIG. 5 may be executed at other time intervals.

In operation S101, the access log collector 11 collects, from the servers 20 to be monitored, access logs stored in the servers 20. In this case, the access logs to be collected are access logs stored in the servers 20 within a time period from a time earlier by a certain time interval than the current time to the current time. The access log collector 11 causes the collected access logs to be stored in the access log storage section 121. The access log storage section 121 may be initialized (or cleared) upon the start of the process procedure illustrated in FIG. 5.

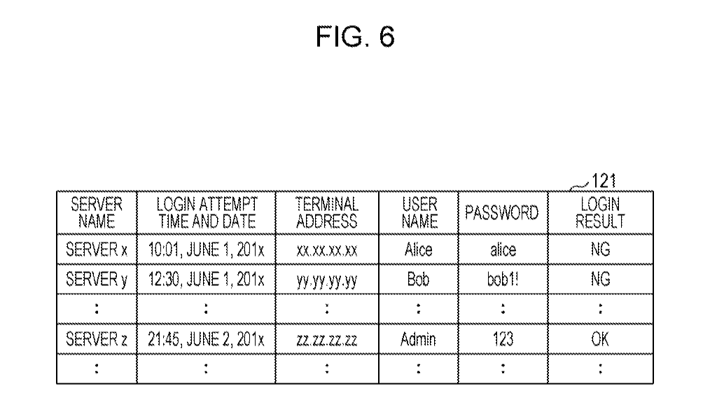

FIG. 6 is a diagram illustrating an example of the configuration of the access log storage section. As illustrated in FIG. 6, the collected access logs are stored in the access log storage section 121. Each of the access logs includes a server name, a login attempt time and date, a terminal address, a user name, a password, and a login result.

The server names are the names of servers 20 targeted for login attempts. The login attempt times and dates are times and dates when the login attempts were made. The terminal addresses are IP addresses of terminals 30 that transmitted the login attempts. The user names and the passwords are user names and passwords that form account information specified in the login attempts. The login results are values indicating whether or not the login attempts were successful or failed. NG indicates that a login attempt failed. OK indicates that a login attempt was successful.

Subsequently, the access log analyzer 12 analyzes a group of the access logs newly stored in the access log storage section 121 in operation S101 and generates, for each of combinations of the servers 20 and account information from the terminals 30, a group of login attempt times and dates indicated in access logs related to the combination (in S102). The access log analyzer 12 causes the generated groups to be stored in the analysis result storage section 122. The analysis result storage section 122 is initialized (or cleared) every time the process procedure illustrated in FIG. 5 is started.

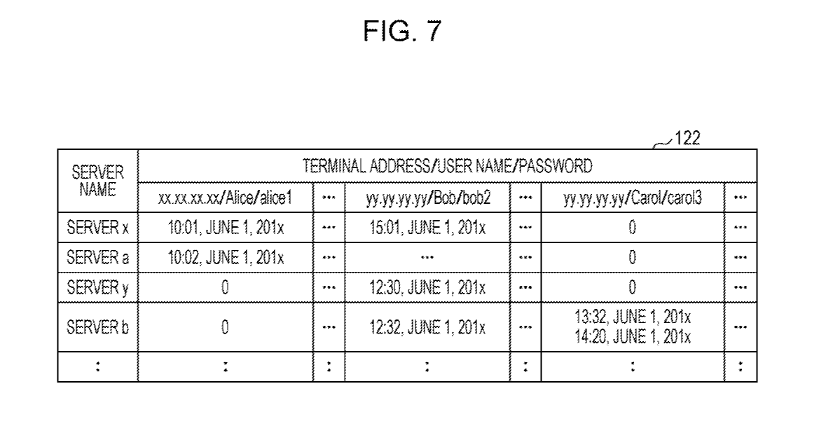

FIG. 7 is a diagram illustrating a first example of the configuration of the analysis result storage section. As illustrated in FIG. 7, for each of combinations of server names and terminal addresses, user names, and passwords, login attempt times and dates indicated in access logs related to the combination are stored in the analysis result storage section 122. In the analysis result storage section 122, the initial values of the items of the combinations are 0. Thus, the value of an item for a combination for which a login attempt is not made is 0. In addition, for a combination for which multiple login attempts were made, multiple login attempt times and dates are stored.

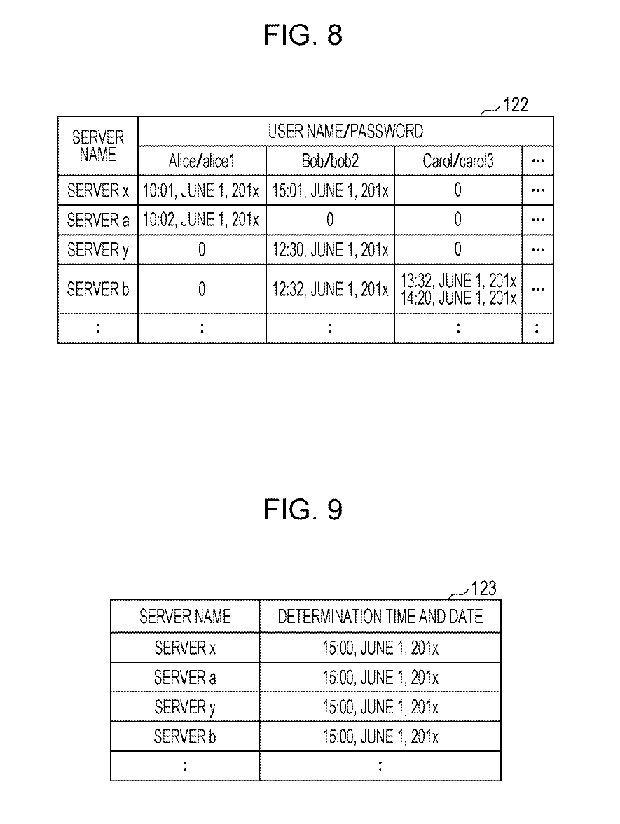

In operation S102, differences between terminal addresses may be ignored. Specifically, the access log analyzer 12 may generate, for each of the combinations of the servers 20 and the account information, a group of login attempt times and dates indicated in access logs related to the combination. In this case, the access result storage section 122 may be configured as illustrated in FIG. 8, for example.

FIG. 8 is a diagram illustrating a second example of the configuration of the analysis result storage section. For each of combinations of server names, user names, and passwords, login times and dates indicated in access logs related to the combination are stored in the analysis result storage section 122 illustrated in FIG. 8. Specifically, in the example illustrated in FIG. 8, columns that are provided for different terminal addresses in the example illustrated in FIG. 7 are combined and provided for common account information.

Subsequently, the STBF detector 13 references the analysis result storage section 122 and determines whether or not the same attempts to log into two or more servers 20 were made (in S103). In this case, the “same attempts” or the “same login attempts” are login attempts indicated in a common column in the analysis result storage section 122. In the example illustrated in FIG. 7, login attempts made from a common terminal address using a common user name and a common password are the same login attempts. In the example illustrated in FIG. 8, login attempts made using a common user name and a common password are the same login attempts.

In the example illustrated in FIG. 7, attempts to log into a server x and a server a from a terminal address “xx.xx.xx.xx” were made using a user name “Alice” and a password “alice1”. In this case, the STBF detector 13 determines that the same attempts to log into two or more servers 20 were made. In the example illustrated in FIG. 7, attempts to log into the server x, a server y, and a server b from a terminal address “yy.yy.yy.yy” were made using a user name “Bob” and a password “bob2”, or the same attempts to log into two or more servers 20 were made.

In the example illustrated in FIG. 8, attempts to log into the server x and the server a were made using the user name “Alice” and the password “alice1”. In this case, the STBF detector 13 determines that the same attempts to log into two or more servers 20 were made. In the example illustrated in FIG. 8, attempts to log into the server x, the server y, and the server b were made using the user name “Bob” and the password “bob2”, or the same attempts to log into two or more servers 20 were made.

A requirement in which the same attempts to log into two or more servers 20 were made “once” may be a requirement for the determination to be made in operation S103. The determination requirement is effective when each of terminals 30 that make STBFs to be detected attempts to log into a single server 20 only once.

Alternatively, a requirement in which the same attempts to log into two or more servers 20 were made a “number N of times or less” may be the requirement for the determination to be made in operation S103. In this case, the number N of times is a threshold for the number of attempts to log into an intrusion detection system (IDS) for detecting a general brute-force attack. Specifically, when the same login attempts whose number exceeds the threshold are made, the IDS detects the occurrence of a brute-force attack.

A requirement in which the same attempts to log into two or more servers 20 were made “once” or the “number N of times or less” is a requirement for excluding a general brute-force attack able to be detected by the general IDS from targets (or STBF) to be detected by the STBF detector 13. In other words, a requirement in which the same attempts to log into two or more servers 20 were made “once” or the “number N of times or less” is a requirement for improving the accuracy of detecting an STBF.

If the same attempts to log into two or more servers 20 were made (Yes in S103), the STBF detector 13 determines that STBFs occurred, and the STBF detector 13 associates the names of the servers 20 targeted for the login attempts with the current time and causes the server names and the current time to be stored in the target server list storage section 123 (in S104). The target server list storage section 123 is initialized (or cleared) every time the process procedure illustrated in FIG. 5 is started.

FIG. 9 is a diagram illustrating an example of the configuration of the target server list storage section. As illustrated in FIG. 9, in the target server list storage section 123, server names and a determination time and date are associated with each other and stored. The determination time and date are a time and date when servers 20 with the server names were determined to be targets of STBFs. The determination time and date are the current time stored in operation S104.

Subsequently, the STBF detector 13 determines whether or not the process of blocking an STBF is being executed (in S105). Specifically, the STBF detector 13 determines whether or not the STBF blocker 14 has been already requested to start the blocking process upon the execution of operation S106 in the previously executed process procedure illustrated in FIG. 5. If the process of blocking an STBF is being executed (Yes in S105), the process procedure illustrated in FIG. 5 is terminated.

If the process of blocking an STBF is not being executed (No in S105), the STBF detector 13 requests the STBF blocker 14 to start the process of blocking an STBF (in S106). The STBF blocker 13 starts the blocking process in accordance with the request.

On the other hand, if the same attempts to log into two or more servers 20 were not made (No in S103), the STBF detector 13 determines whether or not the process of blocking an STBF is being executed (in S107). If the process of blocking an STBF is being executed (Yes in S107), the STBF detector 13 requests the STBF blocker 14 to terminate the process of blocking an STBF (in S108). The STBF blocker 14 terminates the blocking process in accordance with the request. Specifically, since the same attempts to log into two or more servers 20 were not made within the previous certain time interval, it is determined that STBFs were terminated, and the blocking process is terminated.

If the process of blocking an STBF is not being executed (No in S107), operation S108 is not executed.

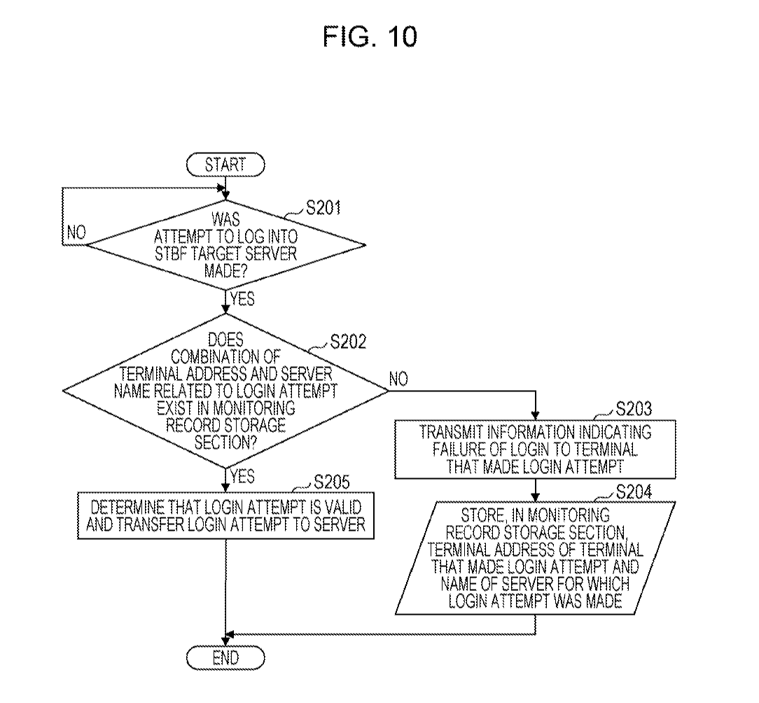

Next, the STBF blocking process to be executed by the STBF blocker 14 in operation S106 is described. FIG. 10 is a flowchart of an example of a procedure for the process of blocking an STBF according to the first embodiment.

When starting the blocking process, the STBF blocker 14 waits for an attempt to log into any of STBF target servers (in S201). The STBF target servers are servers 20 whose server names are stored in the target server list storage section 123 (illustrated in FIG. 9).

When receiving an attempt to log into an STBF target server from any of the terminals 20 (Yes in S201), the STBF blocker 14 whether or not a combination of a terminal address of the terminal 30 that transmitted the login attempt (hereinafter referred to as target login attempt) with the name of the server targeted for the target login attempt is stored in the monitoring record storage section 124 (in S202). Note that the monitoring record storage section 124 is initialized (or cleared) upon the start of the blocking process. Thus, if operation S202 is executed for the first time after the start of the blocking process, the answer to the determination of S202 is No, and the process proceeds to operation S203.

In operation S203, the STBF blocker 14 transmits information indicating a failure of the log into the terminal 30 that transmitted the target login attempt. Operation S203 is a process corresponding to the aforementioned first procedure. Then, the STBF blocker 14 associates the terminal address of the terminal 30 that transmitted the target login attempt, the name of the server 20 targeted for the login attempt, and the current time with each other and causes the terminal address of the terminal 30, the name of the server 20, and the current time to be stored in the monitoring record storage section 124 (in S204).

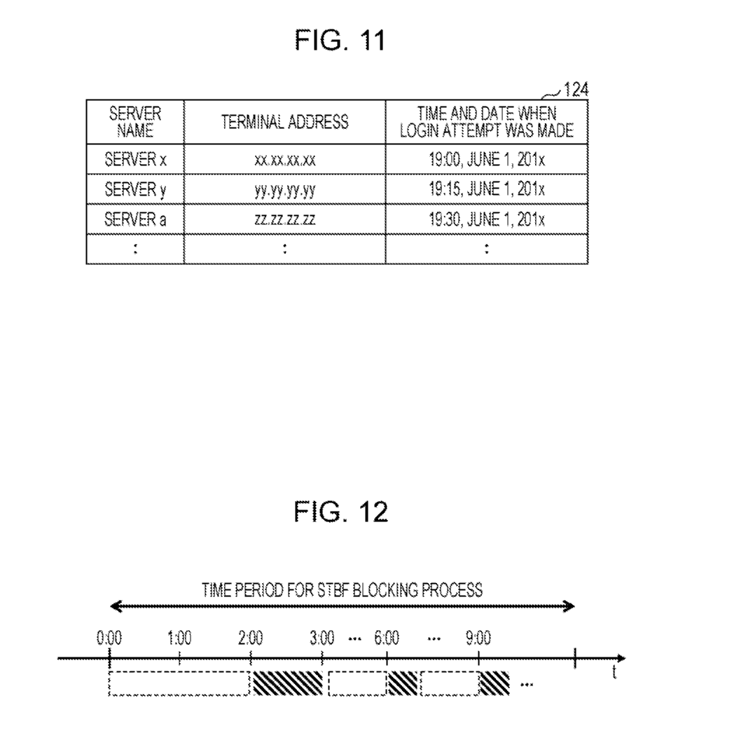

FIG. 11 is a diagram illustrating an example of the configuration of the monitoring record storage section. As illustrated in FIG. 11, for each of terminals 30 that made STBFs or login attempts after the start of the blocking process, the name of the terminal 30, a terminal address of the terminal 30 that transmitted a login attempt, and a time and date when the login attempt was made, are associated with each other and stored in the monitoring record storage section 124.

If the combination of the terminal address of the terminal 30 that transmitted the target login attempt with the name of the server for which the login attempt was made is stored in the monitoring record storage section 124 (Yes in S202), the STBF blocker 14 transfers the target login attempt to the target server 20 (in S205). Specifically, a re-attempt to log into the same server 20 from the same terminal 30 is determined to be a valid login attempt and is transferred to the target server 20. As a result, authentication is executed by the server 20 on a user name and password specified in the target login attempt, and the result of the authentication that indicates whether the authentication was successful or failed is transmitted to the terminal 30 that transmitted the target login attempt. Thus, operation S205 is a process corresponding to the aforementioned second procedure.

If the requirement in which the same attempts to log into two or more servers 20 were made the “number N of times or less” is the requirement for the determination of operation S103 illustrated in FIG. 5, whether or not the number of history records including the combination of the terminal address of the terminal 30 that transmitted the target login attempt with the name of the server 20 targeted for the target login attempt exceeds N may be determined in operation S202 illustrated in FIG. 10. If the number of the history records exceeds N, operation S205 may be executed. If the number of the history records is equal to or smaller than N, operations S203 and S204 may be executed. Specifically, if the requirement in which the same attempts to log into two or more servers 20 were made the “number N of times or less” is the requirement for the determination of operation S103 illustrated in FIG. 5, the same attempt to log into the same server 20 may be made in an STBF up to the number N of times. In this case, the probability of blocking an STBF may be increased by determining that an N+1-th login attempt is made by a valid user.

As described above, in the first embodiment, even if an attempt to log into each server 20 is made by a single terminal 30 a predetermined number of times or less, attempts that are made to log into a plurality of servers 20 with common account information the predetermined number of times or less may be detected by analyzing access logs of the plurality of servers 20. As a result, the occurrence of STBFs may be detected.

In addition, the network monitoring device 10 rejects an initial login attempt from each of the terminals 30 (or rejects the predetermined number of login attempts initially made or less) based on differences between characteristics of login attempts by STBFs and characteristics of login attempts made by a valid user and notifies the servers 20 of re-attempts (made after the predetermined number of login attempts were initially made) to log into the servers 20. Thus, if the valid user uses a different terminal 30 from a terminal 30 usually used by the valid user to attempt to log into the servers 20 after the predetermined number of login attempts are initially made, the login attempts made after the login attempts are initially made are notified to the servers 20. As a result, a login attempt made by a valid user may not be erroneously detected as a login attempt by an STBF and may not be blocked.

According to the above description, in the first embodiment, the accuracy of detecting attacks to attempt to log into each of the servers 20 the predetermined number of times or less may be improved.

In the first embodiment, access logs are analyzed at certain time intervals, and whether or not an STBF occurred is determined. If the occurrence of an STBF is not detected, the blocking process is terminated. Thus, a reduction in usability that may be caused by the continuous execution of the blocking process regardless of the termination of STBFs may be avoided.

### Second Embodiment

Next, a second embodiment is described. The second embodiment describes features different from the first embodiment. Features that are not described in the second embodiment may be the same as or similar to features described in the first embodiment.

A blocking process according to the second embodiment is different from the blocking process according to the first embodiment. Specifically, in the second embodiment, the blocking is executed by rejecting an attempt to log into a server 20 from a terminal 30 that has never successfully logged into the server 20 targeted for the login attempt. In this case, for example, when a valid user who has logged into the server 20 from a personal computer (PC) attempts to log into the server 20 from a smartphone or the like, the login is rejected.

The second embodiment focuses attention on the fact that an attempt to log into each of the servers 20 tends to be periodically made in an STBF. Thus, in the second embodiment, a time period for the blocking process is limited. For example, the blocking is executed in time periods illustrated in FIG. 12.

FIG. 12 is a diagram illustrating an example of the timing of the blocking in the second embodiment. FIG. 12 illustrates the example of the timing of the blocking in a case where it is determined that a login attempt is made at time intervals of 3 minutes. In this case, the blocking is not executed in the first 2 minutes of each of the time intervals and is executed in the last 1 minute of each of the time intervals. In the example illustrated in FIG. 12, the blocking is executed in the time periods indicated by hatched rectangles.

Since the timing of the blocking is limited, the probability of blocking a login attempt made by a valid user may be reduced and a reduction in the usability may be avoided.

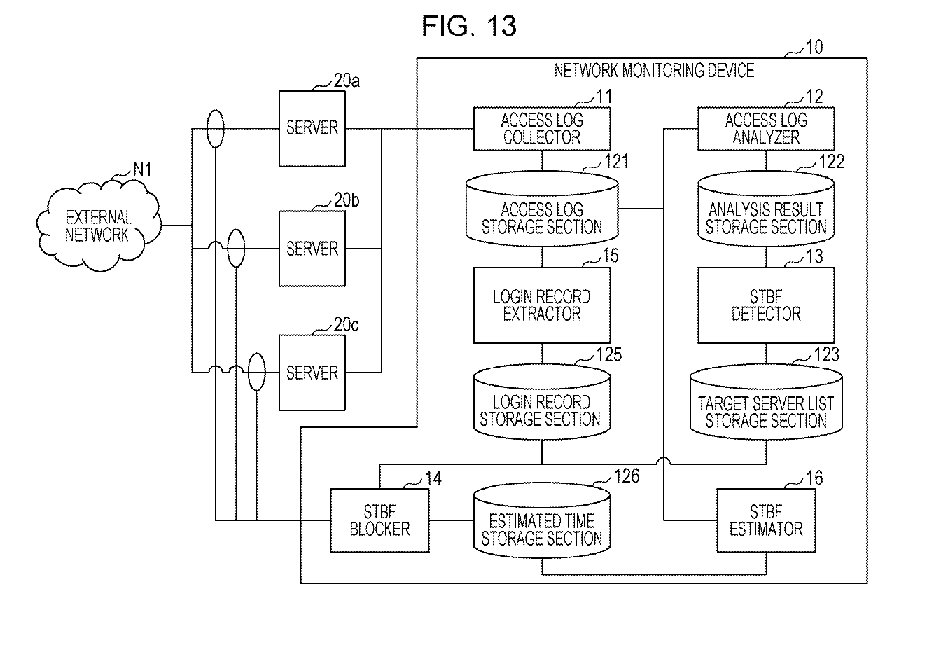

In the second embodiment, in order to achieve the aforementioned blocking, a network monitoring device 10 has such a functional configuration as illustrated in FIG. 13.

FIG. 13 is a diagram illustrating an example of a functional configuration of the network monitoring device 10 according to the second embodiment. Portions that are illustrated in FIG. 13 and are the same as or correspond to those illustrated in FIG. 4 are indicated by the same reference numerals and symbols as those illustrated in FIG. 4, and a description thereof is omitted.

Referring to FIG. 13, the network monitoring device 10 further includes a login result extractor 15 and an STBF estimator 16. These sections are achieved by a process of causing the CPU 104 to execute one or more programs installed in the network monitoring device 10. The network monitoring device 10 further uses a login record storage section 125, an estimated time storage section 126, and the like. These storage sections may be achieved using the auxiliary storage device 102, a storage device able to be connected to the network monitoring device 10 via the network, or the like.

The login record extractor 15 extracts, from access logs stored in the access log storage section 121, an access log indicating successful login and causes information, which indicates that a successful login record exists for a combination of a terminal 30 and server 20 indicated in the extracted access log, to be stored in the login record storage section 125. For each of combinations of the servers 20 and the terminals 30, information indicating whether or not a successful login record exists is stored in the login record storage section 125. The successful login record indicates that login was successful.

The STBF estimator 16 calculates cycles (intervals) of login attempts by STBFs for each STBF target server based on information stored in the analysis result storage section 122 (illustrated in FIG. 7 or 8) and information stored in the target server list storage section 123 (illustrated in FIG. 9). The STBF estimator 16 calculates, based on the calculated cycles, estimated values of future times and dates when login attempts by STBFs are made. STBF estimator 16 causes the calculated estimated values to be stored in the estimated time storage section 126.

In the second embodiment, the network monitoring device 10 may not use the monitoring record storage section 124.

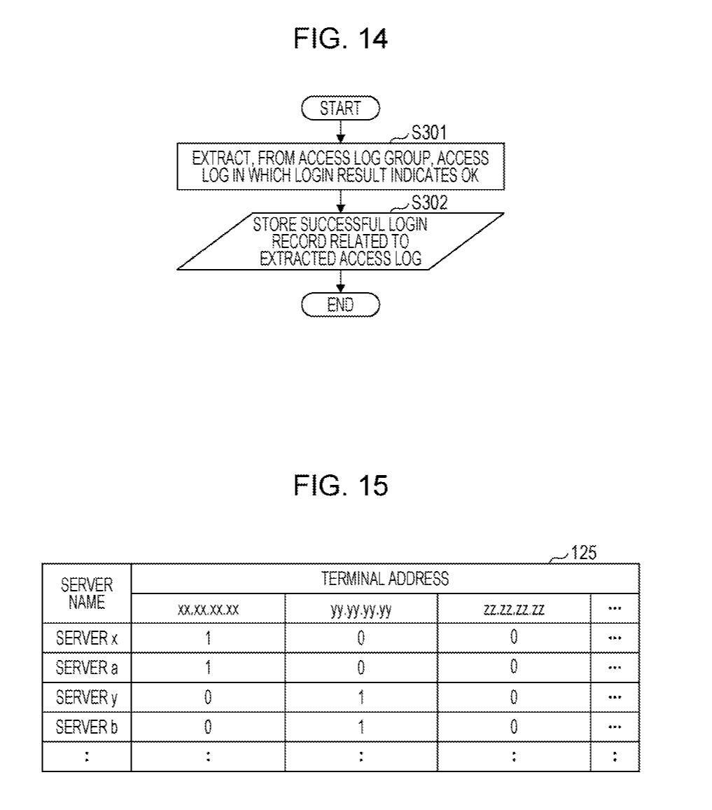

A procedure for a process to be executed by the network monitoring device 10 according to the second embodiment is described below. FIG. 14 is a flowchart of an example of the procedure for the process of extracting a successful login record. The process procedure illustrated in FIG. 14 may be executed in parallel with operation S102 or executed in series with operation S102 before or after operation S102.

In operation S301, the login record extractor 15 extracts, from the access log group newly stored in the access log storage section 121 in operation S101, an access log in which the value of a login result indicates OK. Then, the login record extractor 15 causes information, which indicates that a successful login record exists for a combination of a server name and terminal address indicated in the extracted access log, to be stored in the login record storage section 125 (in S302).

FIG. 15 is a diagram illustrating an example of the configuration of the login record storage section. As illustrated in FIG. 15, for each of combinations of server names and terminal addresses, information indicating whether or not a successful login record exists is stored in the login record storage section 125. The information indicates 1 or 0. The value 1 indicates that a successful login record exists. The value 0 indicates that a successful login record does not exist. Thus, in operation S302, 1 is stored for an item that is among items corresponding to the combinations of the server names and the terminal addresses and corresponds to the combination of the server name and terminal address indicated in the extracted access log.

The login record storage section 125 is not initialized every time access logs are collected. Specifically, information stored in the login record storage section 125 is cumulative information.

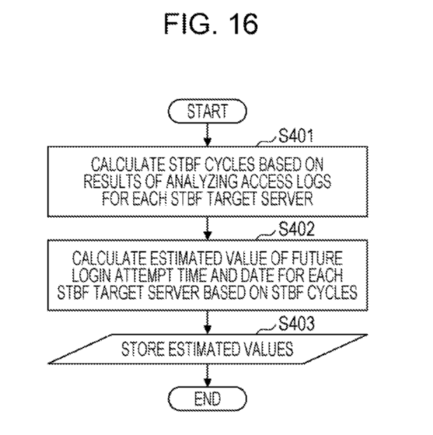

FIG. 16 is a flowchart of an example of a procedure for a process of estimating a future time period when a login attempt by an STBF is made. The process procedure illustrated in FIG. 16 is executed between operation S104 and operation S105 illustrated in FIG. 5, for example.

In operation S401, the STBF estimator 16 calculates cycles (hereinafter referred to as “STBF cycles”) of login attempts by STBFs based on information stored in the analysis result storage section 122 (illustrated in FIG. 7 or 8) for each of STBF target servers whose server names are stored in the target server list storage section 123 (illustrated in FIG. 9) (in S401).

For example, STBF cycles of attempts to log into a certain server 20 are calculated based on a group of login attempt times and dates stored in a row corresponding to the name of the certain server 20 in the analysis result storage section 122. Login attempt times and dates other than STBF login attempt times and dates may be excluded from the group or may not be excluded from the group. The STBF login attempt times and dates are login attempt times and dates when login attempts satisfying the requirement for the determination of operation S103 illustrated in FIG. 5 were made.

Specifically, a representative value such as the average or central value of intervals between login attempt times and dates included in the group and chronologically continuous may be calculated as each STBF cycle. In this case, an interval that is much smaller than the other intervals may be excluded. Alternatively, another statistical method may be used to calculate the STBF cycles.

STBF cycles are calculated for each of the STBF target servers.

Subsequently, the STBF estimator 16 calculates an estimated value of a future STBF login attempt time and date for each of the STBF target servers based on STBF cycles calculated for the STBF target servers and a group of login attempt times and dates used for the calculation of the STBF cycles of the STBF target servers (in S402). For example, the estimated values of the future times and dates when a number N of login attempts are made may be calculated by cumulatively adding a number N of the STBF cycles to the chronologically latest login attempt time and date among the group of the login attempt times and dates. The maximum value (or the latest login attempt time and date among the estimated login attempt times and dates) of the estimated values may be the latest time and date that is not after a time and date when the next collection of access logs is executed.

Subsequently, the STBF estimator 16 causes the calculated estimated values to be stored in the estimated time storage section 126 (in S403).

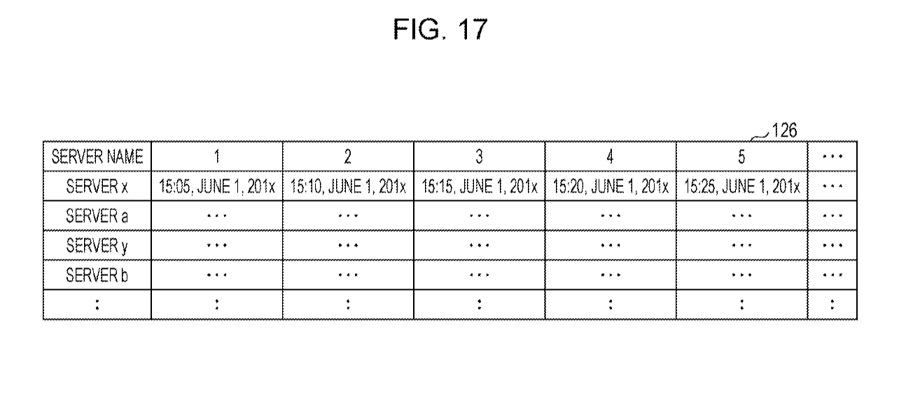

FIG. 17 is a diagram illustrating an example of the configuration of the estimated time storage section. As illustrated in FIG. 17, in the estimated time storage section 126, estimated values of STBF login attempt times and dates are stored for each of server names. In the example illustrated in FIG. 17, STBF cycles of the server x are 5 minutes. Thus, each of intervals between the estimated values of the login attempt times and dates is 5 minutes.

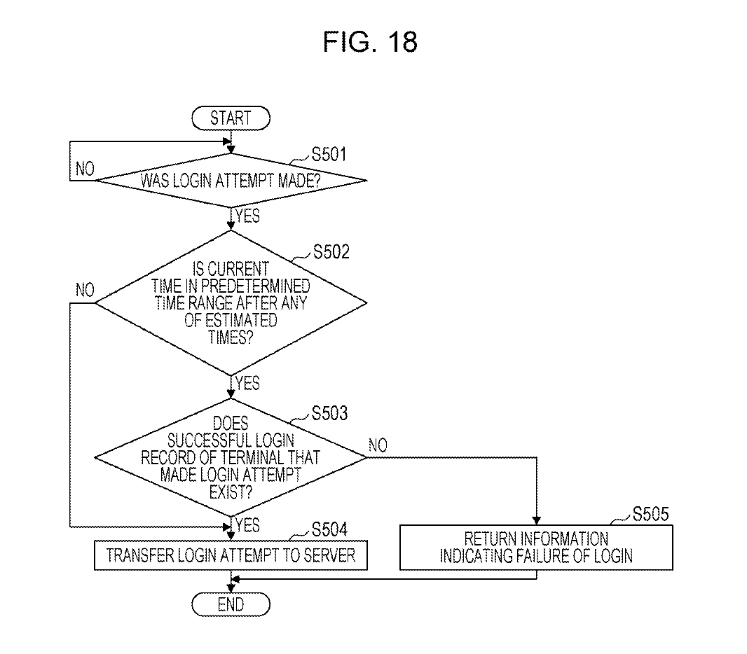

FIG. 18 is a flowchart of an example of a procedure for the process of blocking an STBF according to the second embodiment. The process procedure illustrated in FIG. 18 is started for each STBF target server in operation S106. An STBF target server on which the process procedure illustrated in FIG. 18 is executed is referred to as a “target server”.

When starting the blocking process, the STBF blocker 14 waits for an attempt to log into the target server (in S501). When receiving the attempt (hereinafter referred to as “target login attempt”) to log into the target server (Yes in S501), the STBF blocker 14 determines whether or not the current time is in a predetermined time range after any of estimated times stored for the target server in the estimated time storage section 126 (in S502). In this case, the predetermined time range may be a predetermined percentage (for example, 5% or the like) of an STBF cycle of the target server or may be a fixed time of 10 seconds, 5 minutes, or the like. In operation S502, the STBF blocker 14 may determine whether or not the current time is in a predetermined time range (or in a half of the predetermined time range) including time ranges before and after any of the estimated times. Alternatively, in operation S502, the STBF blocker 14 may determine whether or not the current time is in a predetermined time range before any of the estimated times or in a predetermined range after any of the estimated times.

If the current time is in a predetermined time range after any of the estimated times stored in the estimated time storage section 126 (Yes in S502), the STBF blocker 14 references the login record storage section 125 and determines whether or not a successful login record indicating that the terminal 30 that transmitted the target login attempt successfully logged into the target server exists in the login record storage section 125 (in S503). Specifically, the STBF blocker 14 determines whether or not a value associated with a combination of a terminal address of the terminal 30 and the name of the target server is 1 in the login record storage section 125.

If the successful login record indicating that the terminal 30 that transmitted the target login attempt successfully logged into the target server exists (Yes in S503), the STBF blocker 14 transfers the target login attempt to the target server (in S504). As a result, authentication is executed by the target server on a user name and password specified in the target login attempt, and information that indicates whether the authentication was successful or failed is transmitted to the terminal 30 that transmitted the target login attempt.

On the other hand, if the successful login record indicating that the terminal 30 that transmitted the target login attempt successfully logged into the target server does not exist (No in S503), the STBF blocker 14 transmits information indicating a failure of the log into the terminal 30 that transmitted the target login attempt (in S505).

If the current time is not in a predetermined time range after any of the estimated times stored in the estimated time storage section 126 (No in S502), operation S503 is not executed and the process proceeds to operation S504. Specifically, the blocking of a login attempt is not executed within a time period other than the predetermined time range after the estimated time.

As described above, in the second embodiment, a time period for blocking a login attempt may be reduced. As a result, a reduction in the usability that may be caused by the blocking of a login attempt may be avoided.

The first and second embodiments may be combined. For example, a time period in which the blocking process according to the first embodiment is valid may be limited to periodical predetermined time periods as described in the second embodiment. Alternatively, the blocking process according to the first embodiment and the blocking process according to the second embodiment may be periodically alternately executed.

In each of the embodiments, the servers 20 are an example of information processing devices. The STBF detector 13 is an example of a detector. The STBF blocker 14 is an example of a rejecter. The STBF estimator 16 is an example of a calculator. The access logs are an example of history record information on login attempts.

The embodiments are described above, but are not limited to the above description and may be modified and changed without departing from the gist of the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A network monitoring device comprising:
a memory; and
a processor coupled to the memory and the processor configured to:
detect, based on history record information on attempts to log into a plurality of information processing devices from a plurality of terminals via a network, occurrences of attempts that were made to log into the plurality of information processing devices with common account information a predetermined number of times or less; and
reject an attempt to log into an information processing device among the plurality of information processing devices from a terminal among the plurality of terminals and notify the terminal of a re-attempt to log into the information processing device after the occurrences of attempts are detected.

2. The network monitoring device according to claim 1,
wherein the processor detects the occurrences of attempts that were made to log into the plurality of information processing devices from a common terminal with the common account information the predetermined number of times or less.

3. The network monitoring device according to claim 1,
wherein the processor detects the occurrences of attempts that were made to log into the plurality of information processing devices with the common account information once.

4. The network monitoring device according to claim 1,
wherein the processor detects, within each of predetermined time periods, the occurrences of attempts that were made to log into the plurality of information processing devices with the common account information the predetermined number of times or less, based on history record information obtained within the predetermined time periods, and
wherein if the occurrences of attempts are not detected, the processor does not reject the attempt to log into the information processing device.

5. The network monitoring device according to claim 1,
wherein the processor:
detects, based on history record information on attempts to log into any of a plurality of information processing devices from a plurality of terminals via a network, occurrences of attempts that were made to log into the plurality of information processing devices with common account information a predetermined number of times or less,
calculates, for each of the plurality of information processing devices, a cycle of attempts to log into the information processing device, based on the history record information, and
rejects, for each of the plurality of information processing devices within a predetermined time period in the cycle of attempts calculated, an attempt to log into the information processing device from a terminal determined as not having logged into the information processing device, based on the history record information.

6. A network monitoring method executed by a processor, the network monitoring method comprising:
detecting, based on history record information on attempts to log into a plurality of information processing devices from a plurality of terminals via a network, occurrences of attempts that were made to log into the plurality of information processing devices with common account information a predetermined number of times or less; and
rejecting an attempt to log into an information processing device among the plurality of information processing devices from a terminal among the plurality of terminals and notifying the terminal of a re-attempt to log into the information processing device after the occurrences of attempts are detected.

7. The network monitoring method according to claim 6,
wherein the processor detects the occurrences of attempts that were made to log into the plurality of information processing devices from a common terminal with the common account information the predetermined number of times or less.

8. The network monitoring method according to claim 6,
wherein the processor detects the occurrence of attempts that were made to log into the plurality of information processing devices with the common account information once.

9. The network monitoring method according to claim 6,
wherein the processor detects, within each of predetermined time periods, the occurrence of attempts that were made to log into the plurality of information processing devices with the common account information the predetermined number of times or less, based on history record information obtained within the predetermined time period, and
wherein if the occurrences of attempts are not detected, the processor does not reject the attempt to log into the information processing device.

10. The network monitoring method according claim 6,
wherein the processor:
detects, based on history record information on attempts to log into any of a plurality of information processing devices from a plurality of terminals via a network, occurrences of attempts that were made to log into the plurality of information processing devices with common account information a predetermined number of times or less,
calculates, for each of the plurality of information processing devices, a cycle of attempts to log into the information processing device, based on the history record information, and
rejects, for each of the plurality of information processing devices within a predetermined time period in the cycle of attempts calculated, an attempt to log into the information processing device from a terminal determined as not having logged into the information processing device, based on the history record information.

11. A computer-readable non-transitory recording medium storing a program that causes a computer to execute a procedure, the procedure comprising:
detecting, based on history record information on attempts to log into a plurality of information processing devices from a plurality of terminals via a network, occurrences of attempts that were made to log into the plurality of information processing devices with common account information a predetermined number of times or less; and
rejecting an attempt to log into an information processing device among the plurality of information processing devices from a terminal among the plurality of terminals and notifying the terminal of a re-attempt to log into the information processing device after the occurrences of attempts are detected.

12. The computer-readable non-transitory recording medium according to claim 11,
wherein the computer detects the occurrences of attempts that were made to log into the plurality of information processing devices from a common terminal with the common account information the predetermined number of times or less.

13. The computer-readable non-transitory recording medium according to claim 11,
wherein the computer detects the occurrence of attempts that were made to log into the plurality of information processing devices with the common account information once.

14. The computer-readable non-transitory recording medium according to claim 11,
wherein the computer detects, within each of predetermined time periods, the occurrence of attempts that were made to log into the plurality of information processing devices with the common account information the predetermined number of times or less, based on history record information obtained within the predetermined time period, and
wherein if the occurrences of attempts are not detected, the processor does not reject the attempt to log into the information processing device.

15. The computer-readable non-transitory recording medium according claim 11,
wherein the computer:
detects, based on history record information on attempts to log into any of a plurality of information processing devices from a plurality of terminals via a network, occurrences of attempts that were made to log into the plurality of information processing devices with common account information a predetermined number of times or less,
calculates, for each of the plurality of information processing devices, a cycle of attempts to log into the information processing device, based on the history record information, and
rejects, for each of the plurality of information processing devices within a predetermined time period in the cycle of attempts calculated, an attempt to log into the information processing device from a terminal determined as not having logged into the information processing device, based on the history record information.
